(19) United States
(12) Patent Application Publication
(10) Pub. No.: US 2009/0004629 A1
(43) Pub. Date: Jan. 1, 2009

(54) AESTHETIC DENTAL ARCH LAMINATES AND ADHESIVE

(76) Inventors: Laurence Fishman, Hawthorne, CA (US); Martin Giniger, New York, NY (US); Maria Greene, New York, NY (US)

Correspondence Address: MARC E. HANKIN, ESQ., 11414 THURSTON CIRCLE, LOS ANGELES, CA, 90049, US

(21) Appl. No.: 11/768,899

(22) Filed: Jun. 26, 2007

(51) Int. Cl. A61C 5/00

(52) U.S. Cl. 433/217.1

(57) ABSTRACT

The invention relates to a dental kit and method for comfortably improving oral aesthetics, including one or more thin aesthetic dental arch laminates and a non-toxic tackification adhesive. The one or more thin aesthetic dental arch laminates is configured for comfortable, easy, reusable application, adhered to a person's teeth by the non-toxic tackification adhesive, which is not a bonding agent or a cement. The one or more thin aesthetic dental arch laminates can accommodate the person's teeth without tensioning the person's teeth or the one or more thin aesthetic dental arch laminates, enhancing comfort and minimizing breakage.

### FIELD OF INVENTION

This invention relates, generally, to dental kits; more particularly, to dental kits for improving oral aesthetics.

### BACKGROUND

Many people who desire an aesthetically pleasing smile have discolored, dark or stained teeth, chipped or broken teeth, short teeth, and/or spaces between their teeth, or misaligned or maloccluded teeth. People with such problems can be reluctant to smile because of the unattractive appearance of their teeth.

In some cases, patients seek out professional dental therapies to bleach their teeth, at the cost of $500 to many thousands of dollars. The results of such bleaching procedures are often disappointing, painful, unreliable, and short-lived. Furthermore, bleaching procedures cannot correct malpositioning of teeth.

In order to achieve an attractive, flawless smile, it is not uncommon for patients to spend many thousands of dollars for permanent cosmetic dentistry to correct the appearance of their teeth, even though these teeth are sometimes quite healthy. A number of different procedures are currently available to improve a person's appearance and smile. These include caps, crowns, bonding and permanent veneers. However, all of these procedures require preparation and pre-shaping of a tooth, including cutting, drilling, grinding, etching, scraping and other procedures, which are usually accompanied by pain or discomfort to the patient, requiring pain killing shots to be used prior to the procedure. These procedures often cause permanent, irreversible alterations of healthy, normal teeth, usually requiring multiple trips to the dentist and great expense to the patient, often from $1,000 to $3,000, or more, per tooth.

Another form of or restoration is the permanently cemented, individual tooth laminate veneer which requires less removal of tooth structure but still requires irreversible tooth preparation. Moreover, such procedures are quite expensive, running anywhere from $5,000 to $75,000 per set.

Others have attempted to create lower cost, press-on home-bonded veneers sets, which are complicated to apply, and have not gained acceptance by the professional dental community which frowns upon home dentistry involving semi-permanent and dangerous bonding chemicals or semi-permanent cements. Invariably, the patient returns to the dentist with parts of the restoration, bonding agent or cement stuck uncomfortably or otherwise improperly onto their teeth.

Still another method has been published in which no cement, bonding agent or adhering agent is used at all. Instead, a full arch of conjoined aesthetic laminates are constructed to fit very tightly over teeth to achieve a frictional fit through “deforming and snapping over” the contours, heights, and undercuts of teeth. Although this method avoids messy or dangerous bonding agents and cements, this method presents numerous problems to the user. For example, a snap-on, frictional fit can lead to easy “snapping-off,” leading to potentially unreliable and unpredictable use. Furthermore, reliance on a very tight and accurate frictional fit requires extremely accurate dental impressions. Accordingly, a patient and dental professional must incur increased expenses and time to create extremely accurate dental impressions, without deformation, to allow a proper fit. Such increases are inconvenient and costly, for both the patient and the dental professional.

Additionally, the known method requires that the conjoined aesthetic laminates be deformed frequently, each time they are installed or removed from the person's teeth, to snap over undercuts. The known conjoined aesthetic laminates accordingly must be made thicker and more unnatural looking to reduce the risk of breaking too frequently. The resulting thickened appearance results in poor aesthetics. Attempts at improving appearance, by reducing wall thickness, results in fragility and increased susceptibility to breakage. Perhaps the most significant problem inherent in the known method, is that such restorations, which require a very accurate fit and rely on placing a high amount of torque and frictional force onto living teeth, often cause significant dental pain. As much as 20% to 50% of people who have been fitted with such known restorations experience some amount of dental pain and ultimately find that they cannot be comfortably used.

Accordingly, there is a need in the art for an affordable improvement of oral aesthetics, which does not cause user pain, which does not have a thick, unnatural appearance, which is not susceptible to breakage, and which avoids the many other deficiencies of known techniques for improving oral aesthetics.

### SUMMARY OF THE INVENTION

It is an object of the present invention to provide a dental kit for improving oral aesthetics. The kit includes one or more thin aesthetic dental arch laminates, configured for comfortable and easy reusable application to a person's teeth. The one or more thin aesthetic dental arch laminates is configured to enhance comfort by accommodating the person's teeth by gently going over the heights or contours of the person's teeth, without tensioning the person's teeth, without a need for alteration of the person's teeth, and without tensioning the one or more thin aesthetic dental arch laminates, thereby minimizing the risk of breakage. The kit also includes a non-toxic tackification adhesive, configured to comfortably and temporarily adhere the one or more thin aesthetic dental arch laminates to the person's teeth such that the one or more thin aesthetic dental arch laminates is conveniently removable by the person.

Another object of the present invention is to provide a dental kit for improving oral aesthetics. The kit includes one or more thin aesthetic dental arch laminates, configured for comfortable and easy reusable application to a person's teeth. Each of the one or more thin aesthetic dental arch laminates is a single unit comprising a set of veneers attached to each other along a direction of a dental arch, such that the single unit has an appearance of a set of individual teeth and provides ease of application. The kit also includes a non-toxic tackification adhesive, configured to comfortably and temporarily adhere the one or more thin aesthetic dental arch laminates to the person's teeth such that the one or more thin aesthetic dental arch laminates is conveniently removable by the person. The non-toxic tackification adhesive comprises a non-toxic wax compatible with oral preparation, a non-toxic gum compatible with oral preparation, an orally acceptable glue compatible with oral preparation, and an orally acceptable volatile organic vehicle compatible with oral preparation.

Yet another object of the present invention relates to providing a method of improving oral aesthetics. The method includes providing one or more thin aesthetic dental arch laminates, configured for comfortable and easy reusable application to a person's teeth. The one or more thin aesthetic dental arch laminates is configured to enhance comfort by accommodating the person's teeth by gently going over the heights or contours of the person's teeth, without tensioning the person's teeth, without a need for alteration of the person's teeth, and without tensioning the one or more thin aesthetic dental arch laminates, thereby minimizing the risk of breakage. The method further includes providing a non-toxic tackification adhesive, configured to comfortably and temporarily adhere the one or more thin aesthetic dental arch laminates to the person's teeth such that the one or more thin aesthetic dental arch laminates is conveniently removable by the person.

### BRIEF DESCRIPTION OF THE DRAWINGS

FIG. 1 is an illustration from a front view of one embodiment of the invention.

FIG. 2 is an illustration from a bottom view of another embodiment of the invention.

FIG. 3 is an illustration from a front view depicting a person's teeth prior to application of one embodiment of the invention.

FIG. 4 is an illustration from a front view depicting the application of one embodiment of the invention.

FIG. 5 is an illustration from a front view of one embodiment of the invention while in an applied position.

FIG. 6 is an illustration from a front view depicting an exemplary dispensing bottle for use in conjunction with one embodiment of the invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

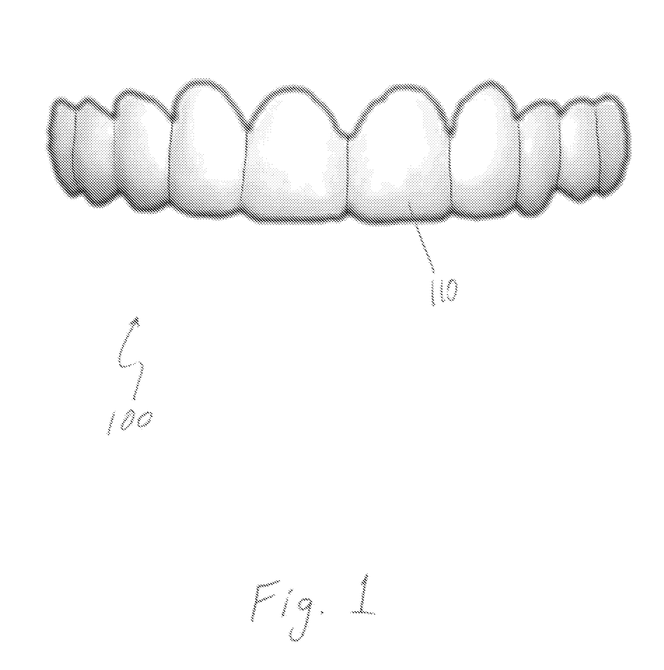

FIG. 1 is an illustration from a front view of one embodiment of the invention. A hollow, thin aesthetic dental arch laminate 100 is shown. More particularly, thin aesthetic dental arch laminate 100 is a maxillary arch laminate, configured to be fitted to a person's maxillary dental arch. The thin aesthetic dental arch laminate 100 is shaped to have the appearance of individual teeth 110, although the thin aesthetic dental arch laminate 100 is hollow to accommodate a person's own teeth when fitted. As illustrated, the thin aesthetic dental arch laminate 100 is a single unit forming one full arch to fit over the person's entire dental arch. However, it is possible to provide multiple thin aesthetic dental arch laminates, in the form of partial arches, usable together. Furthermore, embodiments of the invention include multiple thin aesthetic dental arch laminates, each corresponding to the upper and lower dental arch. The thin aesthetic dental arch laminate 100 is convenient and easy to install, especially in embodiments where the thin aesthetic dental arch laminate 100 has a one-piece construction.

The thin aesthetic dental arch laminate 100 can be custom made by taking a mold of a person's teeth and making the thin aesthetic dental arch laminate 100 based on the mold. There is no need to cut, destroy, remove, or otherwise alter the natural tooth structure. The mold can be taken in a dental professional's place of business using known dental mold techniques. The thin aesthetic dental arch laminate 100 can be made economically from the mold in a dental laboratory, thus enabling a savings of time and expense in producing the thin aesthetic dental arch laminate 100. The person and the dental professional can together choose a color for the thin aesthetic dental arch laminate 100, such that there are no surprises when the thin aesthetic dental arch laminate 100 is obtained.

The thin aesthetic dental arch laminate 100 can be made of plastic, such as a durable, injection molded plastic, or a veneer-form of plastic. The thin aesthetic dental arch laminate 100 is configured such that when fitted, both the person's teeth and the thin aesthetic dental arch laminate 100 are free from tight frictional or torsional forces. Accordingly, the thin aesthetic dental arch laminate 100 can be made with a very thin wall thickness, without risk of increased breakage. For example, wall thickness can be less than 1.0 mm, for example from 0.1 mm to 0.9 mm. Having a thin wall thickness enables the thin aesthetic dental arch laminate 100 to have a natural and cosmetically appealing appearance. The thin aesthetic dental arch laminate 100 can be constructed such that a person's smile is not overly exaggerated by a too-wide or too-tall dental appearance. Furthermore, the thin aesthetic dental arch laminate 100 can have a wall structure which provides for a constant or varying wall thickness, and the wall structure and/or material can provide a constant or varying elastic modulus.

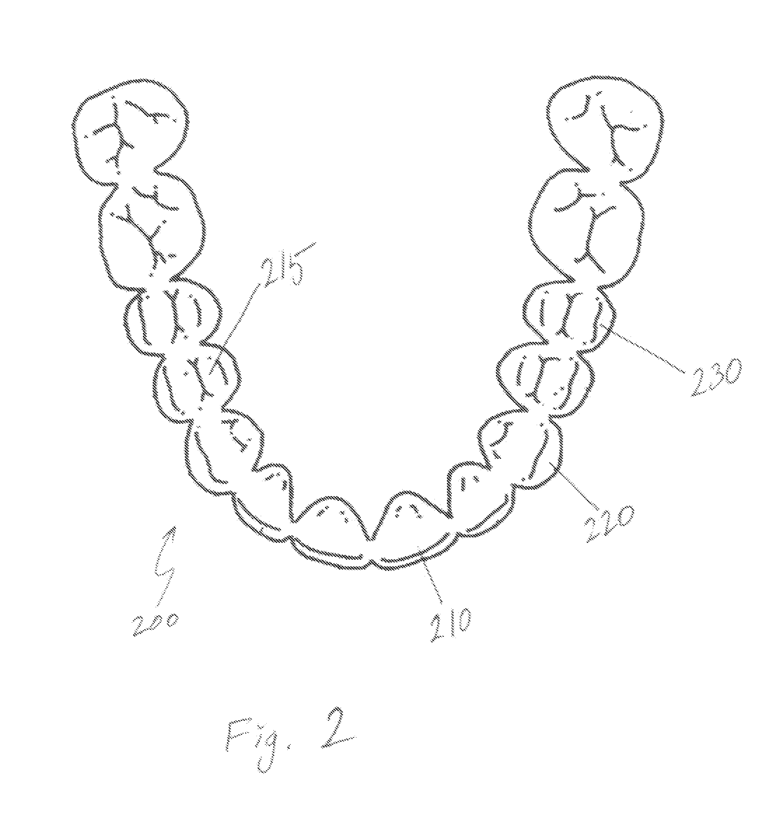

FIG. 2 is an illustration from a bottom view of one embodiment of the invention. A hollow, thin aesthetic dental arch laminate 200 is shown. More particularly, thin aesthetic dental arch laminate 200 is a mandibular arch laminate, configured to be fitted to a person's mandibular dental arch. The thin aesthetic dental arch laminate 200 is shaped to have the appearance of individual teeth 210, although the thin aesthetic dental arch laminate 200 is hollow to accommodate a person's own teeth when fitted. More particularly, the thin aesthetic dental arch laminate 200 includes hollow portions 215, each corresponding to one of the person's teeth. As illustrated, the thin aesthetic dental arch laminate 200 is a single unit forming one full arch to fit over the person's entire dental arch.

Thin aesthetic dental arch laminate 200 can include individual restorations, to restore the morphology of missing or otherwise aesthetically imperfect tooth structure. The individual restorations can be configured to fit over one or more teeth, shaped to restore incisor 210, canine 220, and bicuspid 230. Individual restorations provide benefits of strength and consistent appearance, as an alternative to an unfilled hollow portion of thin aesthetic dental arch laminate 200.

Wall material composition and thickness can be constructed to be partially and/or selectively translucent. This provides the benefit of allowing the underlying natural dental coloration to affect the appearance of thin aesthetic dental arch laminate 200. However, thin aesthetic dental arch laminate 200 enables a typical user to obtain an improved color, similar to the benefit of bleaching, but which can last for years.

Depending on the material composition and wall thickness of the thin aesthetic dental arch laminate 200, the color and appearance of a hollow portion of the thin aesthetic dental arch laminate 200, remaining unfilled by underlying tooth or other structure, may be visibly improved by individual restorations or other structures (including variations in wall structure and material, or an opaque non-toxic tackification adhesive). Individual restorations can be used in conjunction with either, or both of, the maxillary or mandibular arch laminates, or any combination of multiple partial aesthetic dental arch laminates.

The thin aesthetic dental arch laminates 200 are fitted and adhered using a non-toxic tackification adhesive. The non-toxic tackification adhesive is not a bonding agent, cement, or other semi-permanent adhesive. Rather, it is a thickened and tackified, one-part adhesive that is convenient to apply and remove. Its texture can be similar to that of known denture adhesives, and it is capable of adhering to a person's teeth or surrounding soft-tissue. Accordingly, the non-toxic tackification adhesive is temporary and reusable, such that a person can easily reapply the non-toxic tackification adhesive for daily use. Since the non-toxic tackification adhesive is a one-part formulation, there is no need to measure, mix, or otherwise prepare the adhesive. Furthermore, the non-toxic tackification adhesive can be easily removed from the person's teeth and aesthetic dental arch laminates 200. The aesthetic dental arch laminates 200 can be cleaned, for example, by brushing with a toothbrush, by using a cold water denture cleaner, or by using a cotton or foam-tipped swab, among other known denture-cleaning regimens.

The non-toxic tackification adhesive can preferably include a mixture of a non-toxic wax, a non-toxic gum, an orally acceptable glue, and an orally acceptable volatile organic vehicle. The non-toxic wax can include bees wax, micro-crystalline wax, carnauba wax, or similar non-toxic wax used in oral preparations. The non-toxic gum can include carrageenan gum, guar gum, xanthan gum, or similar gum used in oral preparations. The orally acceptable glue can include Gantrez, such as Gantrez MS-955, or those forms of glue typically found in oral preparations. The non-toxic tackification adhesive can also include a flavoring to freshen breath, reduce oral bacteria and prevent caries.

The orally acceptable volatile organic vehicle enables the non-toxic tackification adhesive to flow readily such that it can be dispensed neatly, conveniently, and in a controlled fashion. Shortly after being dispensed from its storage container, the orally acceptable volatile organic vehicle rapidly dissipates from the non-toxic tackification adhesive, which causes the non-toxic tackification adhesive to thicken and tackify for increased adhesive force.

The non-toxic tackification adhesive provides an adhesive force between the thin aesthetic dental arch laminates 200 and the person's teeth and surrounding soft tissue, which enables the thin aesthetic dental arch laminates 200 to be worn and adhered to the person's teeth without relying on tight frictional and/or torsional forces between the thin aesthetic dental arch laminates 200 and the person's teeth. Accordingly, comfort is increased when wearing the thin aesthetic dental arch laminates 200. Furthermore, the thin aesthetic dental arch laminates 200 and the person's teeth are free from torsional forces, which minimizes the risk of breaking the thin aesthetic dental arch laminates 200 and maximizes the person's comfort in wearing the thin aesthetic dental arch laminates 200.

Another benefit of adhering the thin aesthetic dental arch laminates 200 through use of the non-toxic tackification adhesive is that the thin aesthetic dental arch laminates 200 have greater tolerances for variations between the patient's teeth and the accommodating shape of the thin aesthetic dental arch laminates 200. Additionally, the non-toxic tackification adhesive can be configured to have an opaque color which substantially matches the color of the aesthetic dental arch laminates 200. Accordingly, the non-toxic tackification adhesive can serve as an underlying structure to maintain the visual consistency of the thin aesthetic dental arch laminates 200 by filling in or otherwise reinforcing hollow portions of the thin aesthetic dental arch laminates 200 not filled-in by a person's teeth.

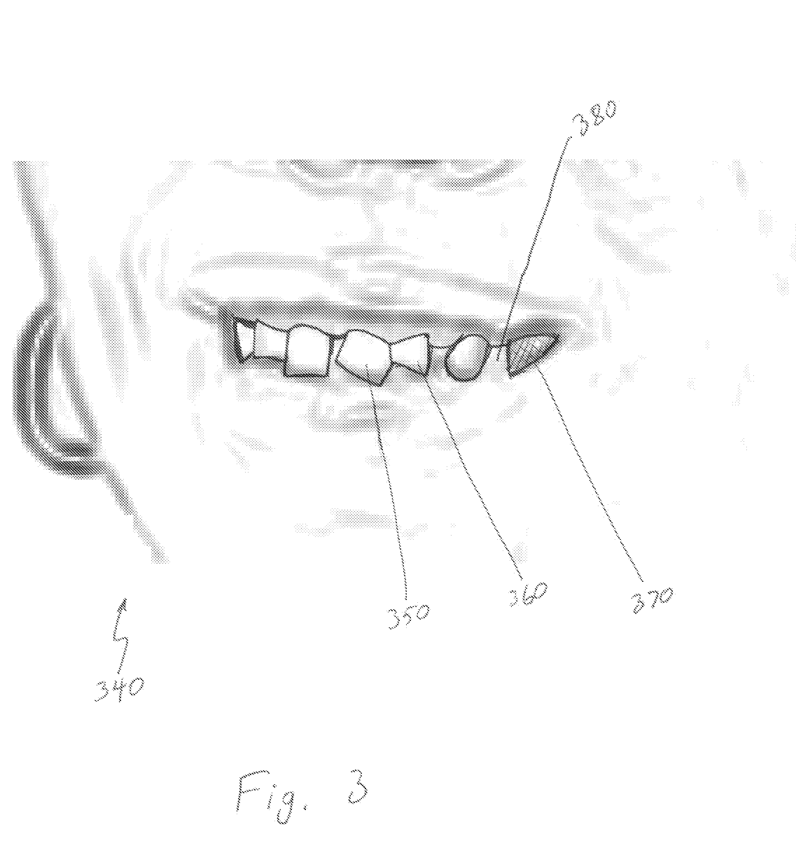

FIG. 3 is an illustration from a front view of a typical user 340 of an embodiment of the present invention. As illustrated, typical user 340 has a crooked tooth 350, a too-short tooth 360, a discolored tooth 370, and a tooth gap 380. The typical user 340 can benefit from the aesthetic dental arch laminates to dramatically transform the aesthetics of the user's smile.

Methods of using embodiments of the invention allow a typical user 340 to be instructed by a dental professional, enabling the typical user 340 to install and remove the thin aesthetic dental arch laminates 300 in everyday settings outside a dental professional's place of business and without the supervision of a dental professional. The thin aesthetic dental arch laminates 300 can be worn occasionally for special occasions, or all the time.

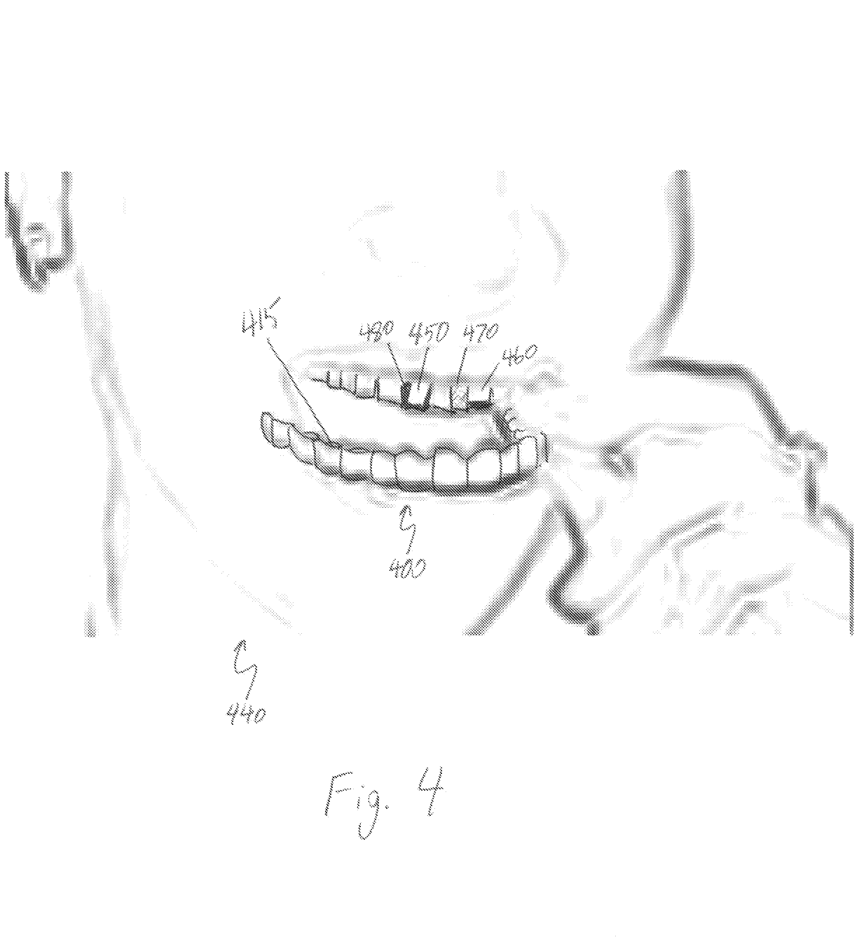

FIG. 4 is an illustration depicting typical user 440 applying an embodiment of the present invention. As illustrated, typical user 440 has a crooked tooth 450, a too-short tooth 460, a discolored tooth 470, and a tooth gap 480. Prior to installation, the typical user 440 applies non-toxic tackification adhesive to the hollow portions 415 of the one or more thin aesthetic dental arch laminates 400. Subsequently, the typical user 440 can wait a moment for the orally acceptable volatile organic vehicle to disperse, causing the non-toxic tackification adhesive to tackify and increase in adhesiveness. The typical user 440 next presses the one or more thin aesthetic dental arch laminates 400 onto the teeth using finger pressure. The typical user 440 can apply enough pressure to comfortably and securely adhere the one or more thin aesthetic dental arch laminates 400 to the user's teeth.

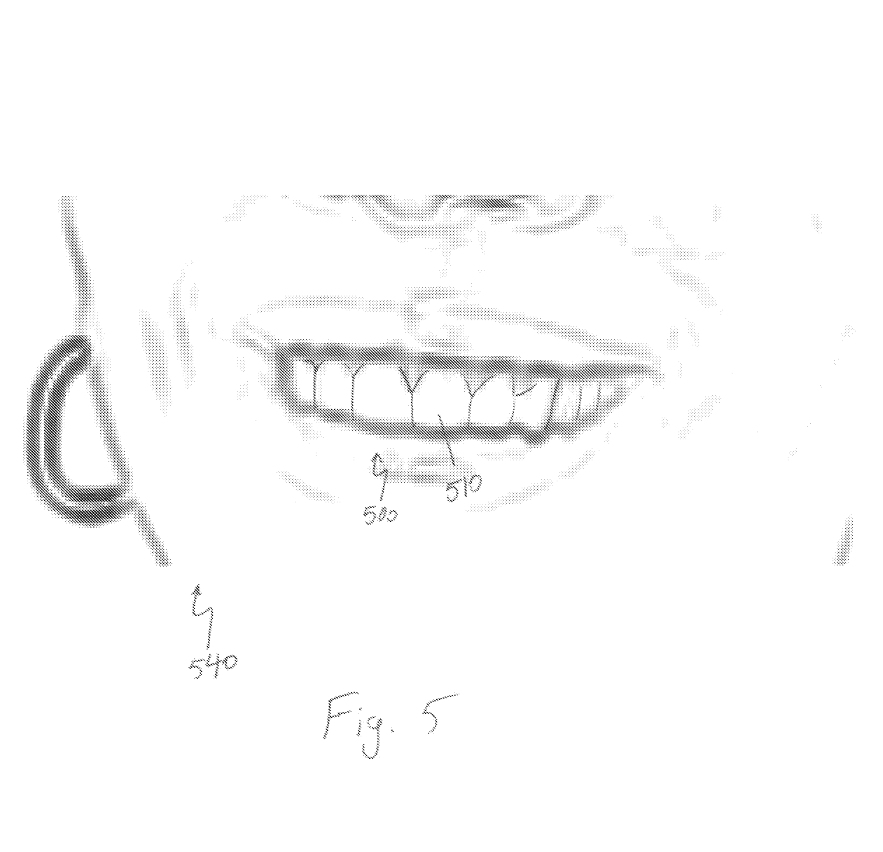

FIG. 5 is an illustration of one embodiment of the invention while in an applied position. Typical user 540 has applied the one or more thin aesthetic dental arch laminates 500 in place, such that they have improved the oral aesthetics of the typical user 540 and hidden any misalignments, malocclusions, or other dental issues. While in place, the one or more thin aesthetic dental arch laminates 500 provides the appearance of individual teeth 510, without unnaturally increasing the width or height of the user's smile. Accordingly, thin aesthetic dental arch laminates 500 provides a useful, comfortable, affordable, and convenient opportunity to obtain a flawless and cosmetically appealing smile.

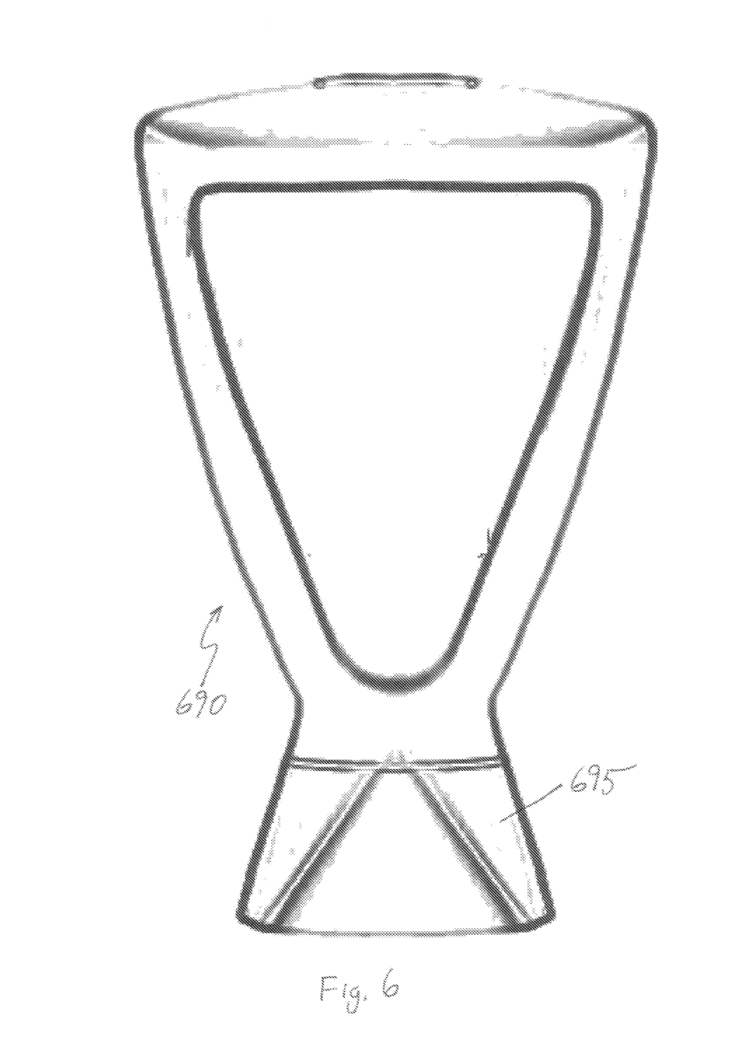

FIG. 6 is an illustration depicting an exemplary dispensing bottle 690 for use in conjunction with one embodiment of the invention. The dispensing bottle 690 is used to store and dispense the non-toxic tackification adhesive, and can include a narrow pointed dropper tip (not visible) to aid in precise control of dispensing the non-toxic tackification adhesive. Furthermore, as illustrated, the dispensing bottle 690 includes a cap 695 configured to allow the dispensing bottle 690 to stand on end. This arrangement enables the non-toxic tackification adhesive to assume a position for convenient dispensing each time the dispensing bottle 690 is used.

The specific embodiments set forth above are for illustrative purposes only, and various modifications and variations from the specific embodiments can be made without departing from the spirit and scope of the invention, as set forth on the following claims.

1. A dental kit for improving oral aesthetics, comprising:
one or more thin aesthetic dental arch laminates, configured for comfortable and easy reusable application to a person's teeth, wherein the one or more thin aesthetic dental arch laminates is configured to enhance comfort by accommodating the person's teeth by gently going over the heights or contours of the person's teeth, without tensioning the person's teeth, without a need for alteration of the person's teeth, and without tensioning the one or more thin aesthetic dental arch laminates, thereby minimizing the risk of breakage; and
a non-toxic tackification adhesive, configured to comfortably and temporarily adhere the one or more thin aesthetic dental arch laminates to the person's teeth such that the one or more thin aesthetic dental arch laminates is conveniently removable by the person.

2. A dental kit according to claim 1, wherein each of the one or more thin aesthetic dental arch laminates is a single unit comprising a set of veneers attached to each other along a direction of a dental arch, such that the single unit has an appearance of a set of individual teeth and provides ease of application.

3. A dental kit according to claim 1, wherein the one or more thin aesthetic dental arch laminates comprises a maxillary arch laminate and a mandibular arch laminate.

4. (canceled)

5. (canceled)

6. A dental kit according to claim 1, wherein the one or more thin aesthetic dental arch laminates is made of a durable, injection molded veneer form of plastic.

7. A dental kit according to claim 1, wherein the one or more thin aesthetic dental arch laminates has a wall thickness of 0.1 mm to 0.9 mm.

8. (canceled)

9. A dental kit according to claim 1, wherein the non-toxic tackification adhesive comprises:
a non-toxic wax compatible with oral preparation;
a non-toxic gum compatible with oral preparation;
an orally acceptable glue compatible with oral preparation; and
an orally acceptable volatile organic vehicle compatible with oral preparation.

10. (canceled)

11. (canceled)

12. (canceled)

13. A dental kit according to claim 9, wherein the non-toxic tackification adhesive is configured to become tackified through rapid dissipation of the orally acceptable volatile organic vehicle after application to the one or more thin aesthetic dental arch laminates, such that when the one or more thin aesthetic dental arch laminates is subsequently pressed onto the person's teeth with finger pressure applied over a period of time, the one or more thin aesthetic dental arch laminates is secured comfortably.

14. A dental kit according to claim 1, wherein the non-toxic tackification adhesive is configured to be easily removed and reapplied to facilitate frequent wearing and removal of the one or more thin aesthetic dental arch laminates.

15. (canceled)

16. A dental kit for improving oral aesthetics, comprising:
one or more thin aesthetic dental arch laminates, configured for comfortable and easy reusable application to a person's teeth, wherein each of the one or more thin aesthetic dental arch laminates is a single unit comprising a set of veneers attached to each other along a direction of a dental arch, such that the single unit has an appearance of a set of individual teeth and provides ease of application; and
a non-toxic tackification adhesive, configured to comfortably and temporarily adhere the one or more thin aesthetic dental arch laminates to the person's teeth such that the one or more thin aesthetic dental arch laminates is conveniently removable by the person, wherein the non-toxic tackification adhesive comprises a non-toxic wax compatible with oral preparation, a non-toxic gum compatible with oral preparation, an orally acceptable glue compatible with oral preparation, and an orally acceptable volatile organic vehicle compatible with oral preparation.

17. A dental kit according to claim 16, wherein the one or more thin aesthetic dental arch laminates is configured to enhance comfort by accommodating the person's teeth by gently going over the heights or contours of the person's teeth, without tensioning the person's teeth, without a need for alteration of the person's teeth, and without tensioning the one or more thin aesthetic dental arch laminates thereby minimizing the risk of breakage.

18. A method of improving oral aesthetics, comprising:
providing one or more thin aesthetic dental arch laminates, configured for comfortable and easy reusable application to a person's teeth, wherein the one or more thin aesthetic dental arch laminates is configured to enhance comfort by accommodating the person's teeth by gently going over the heights or contours of the person's teeth, without tensioning the person's teeth, without a need for alteration of the person's teeth, and without tensioning the one or more thin aesthetic dental arch laminates, thereby minimizing the risk of breakage; and
providing a non-toxic tackification adhesive, configured to comfortably and temporarily adhere the one or more thin aesthetic dental arch laminates to the person's teeth such that the one or more thin aesthetic dental arch laminates is conveniently removable by the person.

19. A method of improving oral aesthetics according to claim 18, wherein each of the one or more thin aesthetic dental arch laminates is a single unit comprising a set of veneers attached to each other along a direction of a dental arch, such that the single unit has an appearance of a set of individual teeth and provides ease of application.

20. A method of improving oral aesthetics according to claim 18, wherein the one or more thin aesthetic dental arch laminates comprises a maxillary arch laminate and a mandibular arch laminate.

21. A method of improving oral aesthetics according to claim 18, further comprising custom fitting the one or more thin aesthetic dental arch laminates, to conform to the person's teeth and extend along a direction of a dental arch over the entire dental arch.

22. (canceled)

23. A method of improving oral aesthetics according to claim 18, wherein the one or more thin aesthetic dental arch laminates is made of a durable, injection molded veneer form of plastic.

24. A method of improving oral aesthetics according to claim 18, wherein the one or more thin aesthetic dental arch laminates has a wall thickness of 0.1 mm to 0.9 mm.

25. (canceled)

26. A method of improving oral aesthetics according to claim 18, wherein the non-toxic tackification adhesive comprises:
a non-toxic wax compatible with oral preparation;
a non-toxic gum compatible with oral preparation;
an orally acceptable glue compatible with oral preparation; and
an orally acceptable volatile organic vehicle compatible with oral preparation.

27. A method of improving oral aesthetics according to claim 26, wherein the non-toxic wax is one of bees wax, micro-crystalline wax, or carnauba wax.

28. A method of improving oral aesthetics according to claim 26, wherein the orally acceptable glue is Gantrez, including Gantrez MS-955.

29. A method of improving oral aesthetics according to claim 26, wherein the non-toxic gum is one of carrageenan gum, guar gum, or xanthan gum.

30. A method of improving oral aesthetics according to claim 26, wherein the non-toxic tackification adhesive is configured to become tackified through rapid dissipation of the orally acceptable volatile organic vehicle after application to the one or more thin aesthetic dental arch laminates, such that when the one or more thin aesthetic dental arch laminates is subsequently pressed onto the person's teeth with finger pressure applied over a period of time, the one or more thin aesthetic dental arch laminates is secured comfortably.

31. A method of improving oral aesthetics according to claim 18, wherein the non-toxic tackification adhesive is configured to be easily removed and reapp lied to facilitate frequent wearing and removal of the one or more thin aesthetic dental arch laminates.

32. (canceled)

33. A method of improving oral aesthetics according to claim 18, further comprising making, by a dental professional, a custom-fitting mold of the person's teeth, in the dental professional's place of business.

34. A method of improving oral aesthetics according to claim 33, further comprising making, at a dental laboratory, the one or more thin aesthetic dental arch laminates based on the custom-fitting mold.

35. A method of improving oral aesthetics according to claim 34, further comprising:
returning the one or more thin aesthetic dental arch laminates from the dental laboratory to the dental professional;
checking, by the dental professional, the fit and appearance of the one or more thin aesthetic dental arch laminates when applied to the person;
making final adjustments, by the dental professional, to the fit and appearance of the one or more thin aesthetic dental arch laminates; and
instructing the person, by the dental professional, as to the proper use and care of the one or more thin aesthetic dental arch laminates, for use in an everyday setting wherein the person may use the one or more thin aesthetic dental arch laminates as frequently as desired without the need to seek assistance from a dental professional.
